(19) United States
(12) Patent Application Publication
(10) Pub. No.: US 2008/0077478 A1
(43) Pub. Date: Mar. 27, 2008

(54) SYSTEMS AND METHODS FOR INTERACTIVELY DELIVERING ADVERTISEMENT UNITS TO A WEB BROWSER

(75) Inventor: Peter H.I. Kim, Pasadena, CA (US)

Correspondence Address: BAKER & MCKENZIE LLP;PATENT DEPARTMENT, 2001 ROSS AVENUE, SUITE 2300, DALLAS, TX, 75201, US

(73) Assignee: INTERPOLS NETWORK INCORPORATED, Pasadena, CA (US)

(21) Appl. No.: 11/932,734

(22) Filed: Oct. 31, 2007

Related U.S. Application Data
(63) Continuation of application No. 09/665,482, filed on Sep. 20, 2000.
Application No. 09/665,482 is a continuation of application No. 60/155,071, filed on Sep. 21, 1999.

(51) Int. Cl. G06Q 30/00; G06F 17/30; G06F 17/40

(52) U.S. Cl. 705/10; 705/14

(57) ABSTRACT

A system for interactive delivery of advertisement units is disclosed. The system includes a client web browser, an advertisement unit database, and an advertisement unit server element. The client web browser is configured to render a web page having a designated location for a first advertisement unit, wherein the first advertisement unit is configured to enable user interactions and submission of user interaction data via a submit function. The advertisement unit database is configured to store a plurality of advertisement units. The advertisement unit server element is communicatively connected to the client web browser and the advertisement unit database element. The advertisement server element is configured to receive the user interaction data, search the plurality of advertisement units in the advertisement unit database element for a second advertisement unit based on the user interaction data and send the second advertisement unit to the client web browser to replace the first advertisement unit in the designated location of the web page.

### APPLICATIONS FOR CLAIM OF PRIORITY

This application claims priority as a continuation application under 35 U.S.C §120 or §365(c) to co-pending U.S. patent application Ser. No. 09/665,482, entitled “METHOD AND APPARATUS FOR DELIVERY OF TARGETED ADVERTISING AND CONTENT BASED ON USER INTERACTION WITH ONLINE QUERIES ON A WIDE AREA NETWORK,” filed on Sep. 20, 2000, which in turn claims priority to U.S. Provisional Application No. 60/155,071 filed Sep. 21, 1999. The entirety of the disclosures of the above-identified applications are incorporated herein by reference as though set forth in full.

### BACKGROUND

I. Field of the Invention

The present invention relates generally to a centralized polling system utilizing Internet technology, and more particularly, to aggregating content and delivering interactive queries or polls and other targeted content to computer users through Web pages.

II. Background of the Invention

Traditionally, advertising campaigns have attempted to target and maximize specific consumer interactivity by designing particular types of advertisements for a specific media. While somewhat directed, such advertising campaigns are still broad based appeals to large demographic segments, with no material customization to the needs, desires, or attitudes of one specific individual. With the advent of the Internet and e-commerce, a form of directed advertising has developed. On the Internet, advertisements frequently appear on Web pages, often in the form of a banner ad prominently located on one or more Web pages. Since the Internet enables real-time interactivity, monitoring, and tracking, it is possible to know when a user views a Web page and when a user selects a particular banner ad.

While monitoring and tracking a user's online behavior may be helpful to achieve better focus for future broadcast of advertisements, it does little to address the fact that many people simply ignore banner ads. Because of their frequent use and often unengaging nature, most users simply ignore them. Without active user participation, the use of banner ads to develop a psychographic profile of users is highly limited. To encourage more user participation, other systems have tried incorporating online polls. However, difficulties in establishing and managing a system for online polls have prevented their industry-wide acceptance. Most Web sites that use online polls create and manage their own online polling activities. Creating and managing their own online polls is quite limited due to the lack of economies of scale. In the case of outsourcing polling software, high costs associated with licensing fees or other conditions of use (e.g., computer users sent to outsourcer's Web site to view banner ads) exist as high hurdles.

Thus, there is a long-awaited and much-needed transformation in the way businesses and individuals utilize the Internet. As Internet portals, e-commerce vendors, and various Web content publishers continue to search for ways to maximize the interactive capabilities of the Internet, the use of online polls has emerged as a popular form of interactive content. The basic mechanics of online polls capture the essence of the Internet, namely multimedia interactivity. The Internet requires at least two (2) people to send information back and forth in order to interact—whether in the form of chat rooms, message boards, email, Web pages, or polls. Whether a business wants to increase brand exposure, syndicate content, identify user interest, or generate leads and collect information, online polls are one of the most effective vehicles to do this on the Internet. For example, polls that are one-question surveys on topics ranging from current events to consumer interests give respondents instant feedback on the tallied results. As poll usage continues to grow across Web sites, Web publishers and marketers will have an inherent need for a centralized poll management system. It would thus be highly desirable to not only provide a centralized system to manage the polling activities for Web publishers, but also to prevent the duplication of user responses, collect useful data on users' declared preferences, and to create the infrastructure to make polling effective and profitable for both Web publishers and marketers.

### SUMMARY

Methods and systems for interactive delivery of advertisement units are disclosed.

In one aspect, a method for interactive delivery of advertisement units to a web browser is disclosed. A webpage is requested from an affiliate content server. The webpage is received in the web browser, wherein the webpage includes a request for a first advertisement unit. The webpage is rendered in the web browser, wherein the rendered webpage includes a designated space for advertisement units. The request for the first advertisement unit is sent to an advertisement server. The first advertisement unit is received. The first advertisement unit within the designated space for advertisement units is rendered. The first advertisement unit is interacted with. The details of the interactions with the first advertisement unit is sent to the advertisement server. The second advertisement unit is selected based on the details of the interaction with the first advertisement unit. The second advertisement unit is sent to the web browser. The second advertisement unit is rendered within the designated space for advertisement units.

In a different aspect, a system for interactive delivery of advertisement units is disclosed. The system includes a client web browser, an advertisement unit database, and an advertisement unit server element.

The client web browser is configured to render a web page having a designated location for a first advertisement unit, wherein the first advertisement unit is configured to enable user interactions and submission of user interaction data via a submit function.

The advertisement unit database is configured to store a plurality of advertisement units. The advertisement unit server element is communicatively connected to the client web browser and the advertisement unit database element. The advertisement server element is configured to receive the user interaction data, search the plurality of advertisement units in the advertisement unit database element for a second advertisement unit based on the user interaction data and send the second advertisement unit to the client web browser to replace the first advertisement unit in the designated location of the web page.

### BRIEF DESCRIPTION OF THE DRAWINGS

For a more complete understanding of the principles disclosure herein, and the advantages thereof, reference is now made to the following descriptions taken in conjunction with the accompanying drawings, in which:

FIG. 1 is a block diagram illustrating the network (WAN) in which information is delivered to users in the form of Web pages containing polls and queries in accordance with the invention;

FIG. 2A is an illustration of a sample entertainment opinion poll;

FIG. 2B is an illustration of a sample entertainment trivia poll;

FIG. 2C is an illustration of a sample direct response poll;

FIG. 2D is an illustration of a sample profile poll;

FIG. 2E is an illustration of a sample sweepstakes trivia poll;

FIG. 2F is an illustration of a mini-survey poll;

FIG. 3A is a flowchart outlining the process of tagging and delivering targeted content to a particular user;

FIG. 3B is a flowchart outlining the process of tagging and recording a particular user's answers to a poll;

FIG. 4 is a flowchart outlining the processes that occur within the Content Provider User Interface;

FIG. 5 is a flowchart outlining the processes that occur within the Marketer User Interface; and

FIG. 6 is flowchart outlining the processes that occur within the Affiliate User Interface.

### DETAILED DESCRIPTION

Individuals who use the Internet are often confronted with numerous banners, advertisements, and other information that seek the attention of those individuals. The present invention deploys interactive queries or polls to appeal to and entertain Internet users, obtain their interest, encourage their responsive interaction, and collect consumer data based on that interaction. The collected data is the basis of building meaningful psychographic profiles that are used to target advertising to specific individuals instantly or at some point later in time.

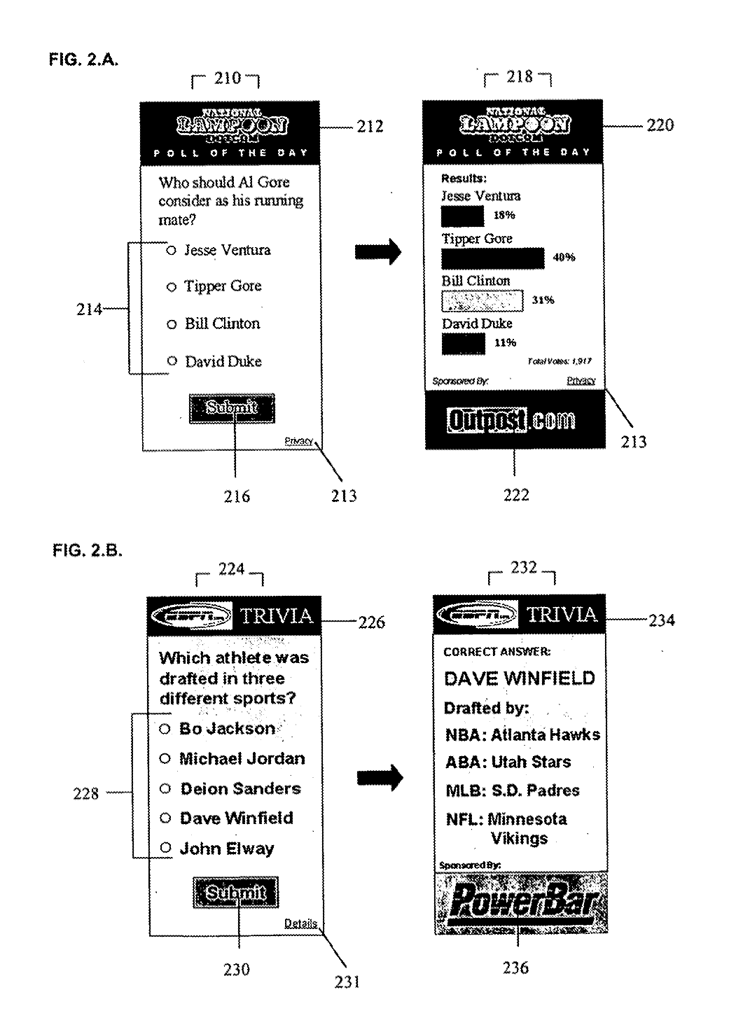

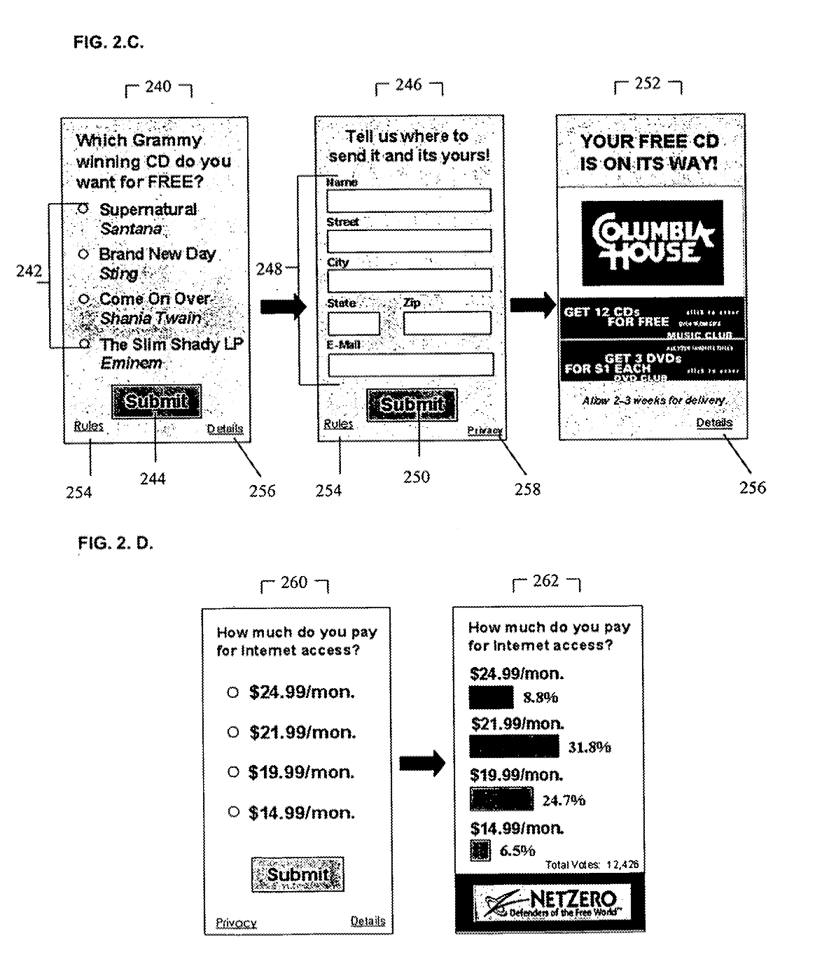

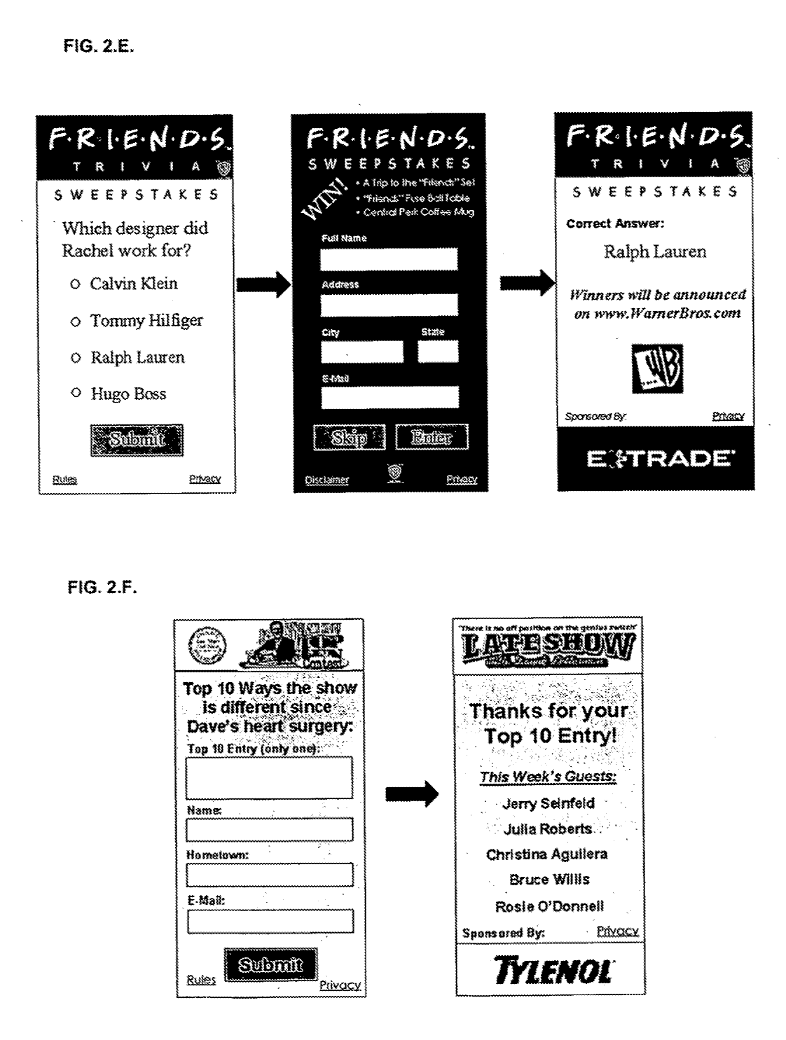

There are preferably five parties who participate in the operation of an embodiment of the present invention. The first party includes the end-user (“Users”), namely persons who use the Internet to read and view various content existing on the World Wide Web. The second party comprises of Web site affiliates (“Affiliates”) who agree to display interactive queries/polls or certain advertising on one or more of its Web pages as selected and delivered in accordance with the operation of the present invention. The third party consists of marketers, advertising agencies, sponsors, or other entities (“Marketers”) that create marketing campaigns, generate poll questions, and select the placement of ads in order to promote specified services and goods. This group includes parties who wish to sponsor certain polls in exchange for advertising space. The fourth party consists of news agencies, media companies, or any other businesses (“Content Providers”) that provide branded poll questions such as entertainment opinion and trivia poll questions, as shown in FIGS. 2A and 2B, and supply the various poll data to be delivered to users. Finally, the fifth party consist of the entity that operates the advertising/poll delivery infrastructure (“System”) that determines when and where to deliver either an advertisement or a poll depending on the nature of the User currently online and the marketing campaign developed by a Marketer.

It should be noted that the Affiliates, Marketers, and Content Providers make up the clients (“Clients”) who utilize the System to reach Users in the present invention. Additionally, it should be appreciated that a Client may play multiple roles in its involvement with the present invention. For example, a single company may serve as: (1) an Affiliate by having certain polls or advertisements appear on their entertainment Web pages; (2) a Marketer by developing and/or sponsoring ad campaigns to appear on other Web sites; and (3) a Content Provider by serving as a source for entertainment trivia polls. It should also be appreciated that in the present invention, an Affiliate may create many different types of polls from two separate families of polls—namely, internal and external polls. As their names suggest, the internal family of polls contain those polls that are created for use only in its own Web sites while the external family of polls contain those polls that are created for use on any Web site, including their own. Other than this distinction, no other differences exist between the internal and external family of polls. In other words, any given poll (e.g., entertainment opinion poll, entertainment trivia poll, direct response poll, profile poll, sweepstakes trivia poll, mini-survey poll, etc.) may be either an internal or external poll, depending on the designation by the party that creates that specific poll. More details on the different types of polls available via the System 120 within these two categories of polls will be provided later.

System

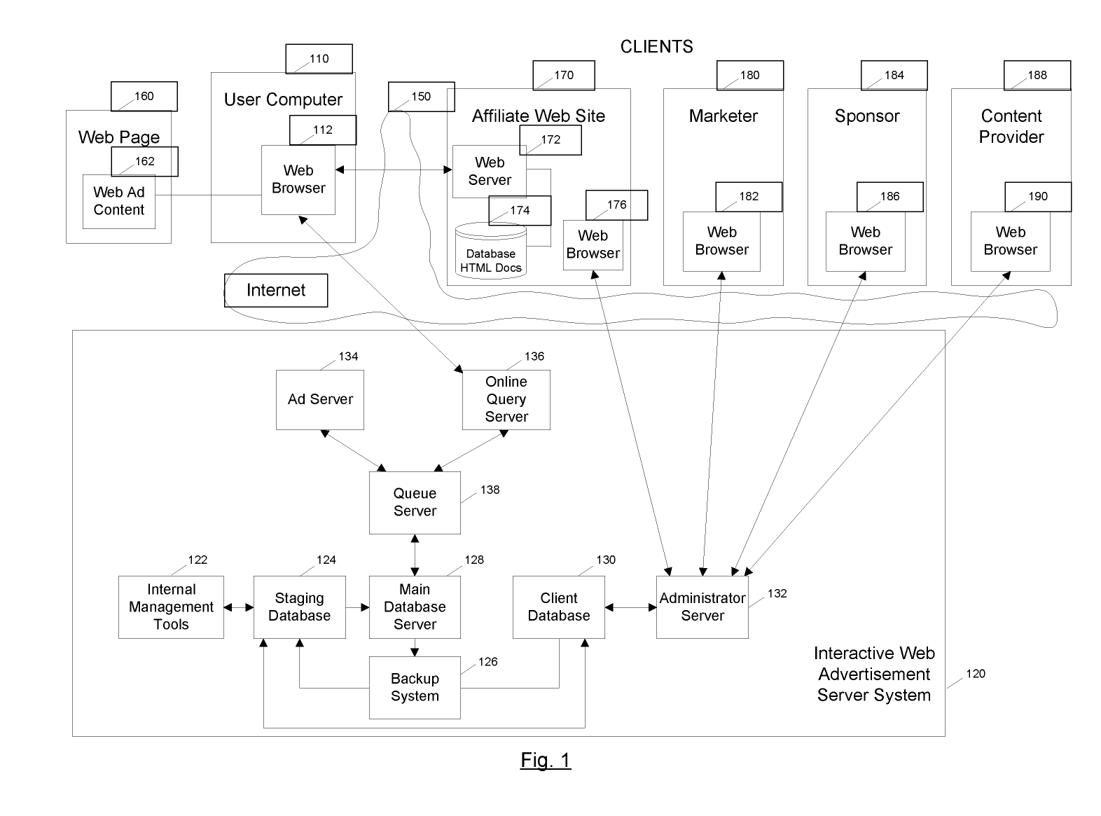

Referring now to FIG. 1, a block diagram is illustrated of a wide area network (WAN) in which information is delivered to users in the form of Web pages containing polls and queries in accordance with the invention. It is anticipated that the present System operate with a plurality of computers which are coupled together on a communications network, such as the Internet or a WAN. FIG. 1 depicts a network that includes a user computer 110 that communicates with the System 120 and the Affiliate Web site 170 through communication links that include the Internet 150. The Affiliate 170, Marketer 180, and Content Provider 188 are also connected to the System 120 and communicate with the administrator server 132 within the System 120 through the Internet 150.

Each one of the user 110, Affiliate 170, Marketer 180, and Content Provider 188 may include any type of computing device that allows the operator to interactively browse Web sites, such as a personal computer (PC) that includes a Web browser application 112, 176, 182, 186 or 190 executing respectively thereon (e.g., Microsoft Internet Explorer□ or Netscape Communicator□). The Affiliate Web site 170 also includes a Web server 172 that can selectively deliver HyperText Markup Language (HTML) documents to the user computer 110 using the HyperText Transport Protocol (HTTP). Currently, HTML 4.0 is the standard used for generating Web documents, though it should be appreciated that other coding conventions could also be used within the scope of the present invention. The Web server 172 accesses a store of HTML documents 174 that can be requested, retrieved, and viewed at the user computer 110 via the Web browser 112. It should be appreciated that many different user computers may be communicating with the Web server 172 at the same time.

Within the System 120, the internal management tools 122 are what the internal staff use to manage operation of the present invention. Using the internal management tools 122, the System staff, for example, approve and classify all the content into their right categories, view Client records, and start and stop individual polling/advertising campaigns. The internal management tools 122 are connected to a staging database server 124 which holds a copy of the live main database server 128. Since it is unstable to make live changes to the System 120, any and all changes are first made to the staging database server 124 and then replicated to the live main database server 128 in a set interval of time (e.g., every 15 minutes). The main database server 128 is the storage area for all activities of the System 120. All of the poll/ad content and User data are stored in the main database server 128 and is backed up all of the time in the backup system 126.

The Clients of the System 120 communicate with the administration server 132 to manage their individual accounts within the System 120. For example, through the administration server 132, Affiliates create or change the look and feel of their polls and Marketers run a new marketing poll/ad. The administration server 132 is connected to the client database 130 where all Client data is stored. All Client activities are saved on the client database 130 and are stored there until the activities are approved by the System staff. Once the Client activities are approved by the System staff, that Client data is replicated to the staging database 124 which is connected to the client database 130. Within the staging database 124, the Client data is ready to be replicated to the main database server 128 in predetermined intervals (e.g., every 15 minutes). The ad server 134 and the poll server 136 are the main front end components to the Internet 150. These cluster of application servers will deliver various polls and advertisements to the user's Web browser 112. Neither the ad server 134 nor the poll server 136 have much logic within the components, since both servers rely completely on the queue server 138 for direction.

The queue server 138 works as the “brain” behind the System 120 by communicating with the main database server 128 on one hand and the ad server 134 and poll server 136 on the other hand. The queue server 138 handles three main functions. First, it keeps track of each of the individual Affiliate Web sites and keeps a list of polls ready to serve per individual Web site. Second, it keeps track of individual Users and maintains a list of targeted ads to deliver to each User. Third, it functions as a caching server between the main database server 128 on one hand and the ad server 134 and poll server 136 on the other hand, so that it will not be necessary to constantly read and write to the main database server 128.

Delivered Content

As generally known in the art, a user identifies a Web page that is desired to be viewed at the user computer 110 by communicating an HTTP request from the browser application 112. The HTTP request includes the Uniform Resource Locator (URL) of the desired Web page, which may correspond to an HTML document 174 stored at the Affiliate Web site 170. The HTTP request is then routed to the Web server 172 via the Internet 150. The Web server 172 then retrieves/generates the HTML document 174 identified by the URL, and communicates the HTML document across the Internet 150 to the browser application 112. The user computer 110 is then able to show the destination Web page 160 through its Web browser 112.

Unlike a conventional Web page, however, the Affiliate Web page 160 displays additional content such as queries, polls, surveys, sponsored content, or other targeted content, referred to collectively herein as polls 162. Although for sake of simplicity the various delivered content are referred to as polls, it should be noted that the delivered content may be any one or a combination of streaming video, games, crossword puzzles, etc., in addition to polls and surveys. Numerous combinations and possibilities exist because the delivered content comprise of a plurality of panels which together make up the entire package. For example, a simple one-question poll will have at least a question/answer panel and a results panel. An example of a more complex package of delivered content would be a question/answer panel asking the user which movie he would like to see along with the available movie choices followed by a subsequent panel showing the streaming video.

Queries, polls, surveys, and advertisement appearing on the affiliate Web page 160 appear in a simple question-and-answer type of format. Referring back to FIGS. 2A and 2B, branded polls such as entertainment opinion 210 and trivia 224 polls seek to draw the users' attention by posing questions related to popular culture, sports, and other interesting topics. Entertainment opinion 210 and trivia 224 polls are given with multiple choice answers 214 and 228 that the user can choose within the question/answer panel. A hyperlink to a privacy statement 213 is also provided at the bottom of the question/answer panel and the results panel of the entertainment opinion 210 poll. Similarly, a hyperlink to a details page 231 is provided at the bottom of the question/answer panel of the entertainment trivia 224 poll. Clicking on these hyperlinks will pop up a new window with the privacy statement or the detailed information. Once the user makes his choice, the user will select the “Submit” button 216 and 230, respectively, to post his answer into the polling database. The Affiliate Web page 160 will refresh and the System 120 will provide the user with the results of the poll 218 and 232. The preferred embodiment of the invention will refresh the same exact content of the Affiliate Web page 160 while replacing the polling box with the results panel (or the next panel to be displayed within the poll). Therefore, the Affiliate Web page 160 will receive multiple user impressions. In another embodiment of the invention, the System 120 will only replace the polling box with the results panel (or the next panel to be displayed within the poll) without refreshing the other contents of the Affiliate Web page 160. As the System 120 delivers the results of the poll to the user, the System 120 also incorporates delivery of appropriate sponsorship information 222 and 236. In this example, Content Provider designs “creatives” 212, 220, 226, and 234 that appear above the questions and results.

Other forms of polls may be incorporated into the Affiliate Web page 160. Direct response polls 240 as seen in FIG. 2C are aimed at obtaining specific user information. As such, certain incentives such as free CD giveaways may be structured as a question to entice users to volunteer information about themselves. In this example, the user may choose the particular CD he wishes to receive from the multiple choices 242 given in the question/answer panel of the poll. Hyperlinks to the rules 254 and the details 256 of the CD-giveaway are provided at the bottom of the question/answer panel of the poll. Clicking on these hyperlinks will pop up a new window with the privacy statement or the detailed information. Once the user The user then selects the “Submit” button 244 to proceed to the next step. The Web page 160 will refresh (again, although the entire Web page will refresh, only the contents within the poll box will change in substance) and the user will be asked to provide personal information 248 such as name, mailing address, and e-mail address within the data entry panel 246. Again hyperlinks to the rules 254 and privacy statements 258 are provided at the bottom of the data entry panel 246. Once the user enters the personal information 248 and selects the “Submit” button 250, the Web page 160 will refresh once more and the advertiser information will appear as the final display panel 252.

Profile polls as shown in FIG. 2D are utilized to obtain direct information about the user. A profile poll has a similar look and feel to the entertainment opinion and trivia polls and has a question/answer panel 260 and a results panel 262. Although any poll may be used to obtain information to build a particular user's psychographic profile, these profile polls are the most useful since they give specific, detailed information about the user. Other methods of gathering user information can be implemented through sweepstakes trivia polls as shown in FIG. 2E and min-survey polls as shown in FIG. 2F. These polls operate in the same manner as the other polls described above.

In operation of the present invention, an Internet user “surfs” from one Web page to another until he reaches an Affiliate Web page 160 containing a poll 162. The poll 162 may be any one of those shown in FIG. 2A through 2D, but will usually consist of a question juxtaposed with a plurality of poll responses. In a preferred embodiment of the invention, a maximum of six poll responses is used so as to limit the amount of space taken up on the screen. The user is encouraged to select what, in his opinion, is the appropriate response to the question posed. Users frequently interact with polls in order to see the poll results and compare themselves against other poll respondents. This unique interactivity and novel method of engaging the user is therefore utilized not only to simply conduct a poll, which is common in the prior art, but primarily to develop a psychographic profile of the user based on his answer to the poll question, and to subsequently tag that user to enable strategic ad and poll delivery in the future. It should be noted that the main purpose of these polls is to start an interactive dialogue with the users, so that the users see multiple screens and interact with targeted content and advertising.

Referring back to FIG. 1, in order to deliver such polls 162 within the Affiliate Web page 160, the particular HTML document 174 that is retrieved has a snippet of code written in JavaScript that instructs the Web browser application 112 of the user computer 110 to communicate with the poll server 136 of the System 120. Each snippet of code contains the Affiliate ID and information concerning the look and feel of the polls that the Affiliate has previously defined. The System 120 determines what kind of content to serve within that space designated on the Affiliate Web page 160. An example of the snippet of code written in JavaScript is as follows:

<script language = “javascript” src =

“http://server.interpolls.com/poll.cfm?clientid=xxxxxxxxxxxx>
</script>

It should be noted that the above example of the snippet code is for representative purposes only and that the actual snippet code may vary depending on each programming instance. In any event, the snippet code is a Client-side javascript (“CSJS”) code that requests further CSJS from the poll server 136. Therefore the user's Web browser 112 contacts the poll server 136 and the poll server 136 in turn retrieves a poll data, then generates a CSJS code that will display a specific poll and sends it to the user. Once the CSJS reaches the user computer 110, the user's Web browser 112 will execute the code and generate the poll.

Tagging a User

As mentioned earlier, the online interaction between the user and the poll forms the basis on which that user's psychographic profile is developed. As such, tagging a user after that user is confronted with a Web page 160 containing a poll 162 is critical in order to track that individual's behavior for future delivery of targeted advertising. One of ordinary skill in the art would appreciate that several methods can be used to tag the user. The user's IP address and the placement of a “cookie” on the user's machine are two ways by which a user can be tagged (i.e., identified for future use). Each method has its limitations, however. IP addresses can be shared among a number of people who use the same proxy, and therefore noting a user's IP address is not a suitable way to uniquely identify one single person. Also, users who connect through an Internet Service Provider (ISP) get a dynamically assigned IP address. Therefore, a user is most likely to have a different IP address each time he connects through an ISP.

A cookie is a piece of information that a Web site, using the user Web browser's 112 facilities, places on the hard disk drive of a user's machine for future use. Cookies are useful because they allow a Web server to store its own information about a user on the user's own computer. Typically, a cookie stores a unique number identifying a user. Thus, although cookies themselves do not usually contain a user's preferences, the unique identification number is used to access a user's particular preferences stored in the System user database. Additionally, since cookies are placed onto the user's machine and therefore can uniquely identify a single user, or more specifically, a single computer terminal, the placement of a cookie file on the user computer 110 after the user responds to a poll question would be the preferred method of tagging users.

The use of cookies to identify the different users has its limitations, however. One drawback to using cookies is that some users block cookies to prevent the clutter of their hard disk drives with the placement of cookie files. Another limitation lies in the fact that to be of use, the System 120 that supports the embodiment of the present invention must be able to read a user's cookie file to determine that particular user's historical interactions with poll questions. Cookie files can only be read, however, by the Web site that creates them. Specifically, the Uniform Resource Locator (URL) specified in the cookie must be the same as the Web site that the user is surfing in order for the browser to send the cookie to the Web site. Therefore, in the preferred embodiment of the invention, the cookies are placed on the user computer 110 by the System 120 and not by the individual Affiliate Web site 170. Since an Affiliate web page 160 may contain information from multiple sources, as the user's Web browser 176 communicates with the System 120 to retrieve the next set of javascript code, the System 120 can read and place the cookie using one centralized domain name of the System 120. When it later becomes necessary to examine the user computer 110 for a tag, the poll server 136 can do so by accessing the cookie file that it placed previously.

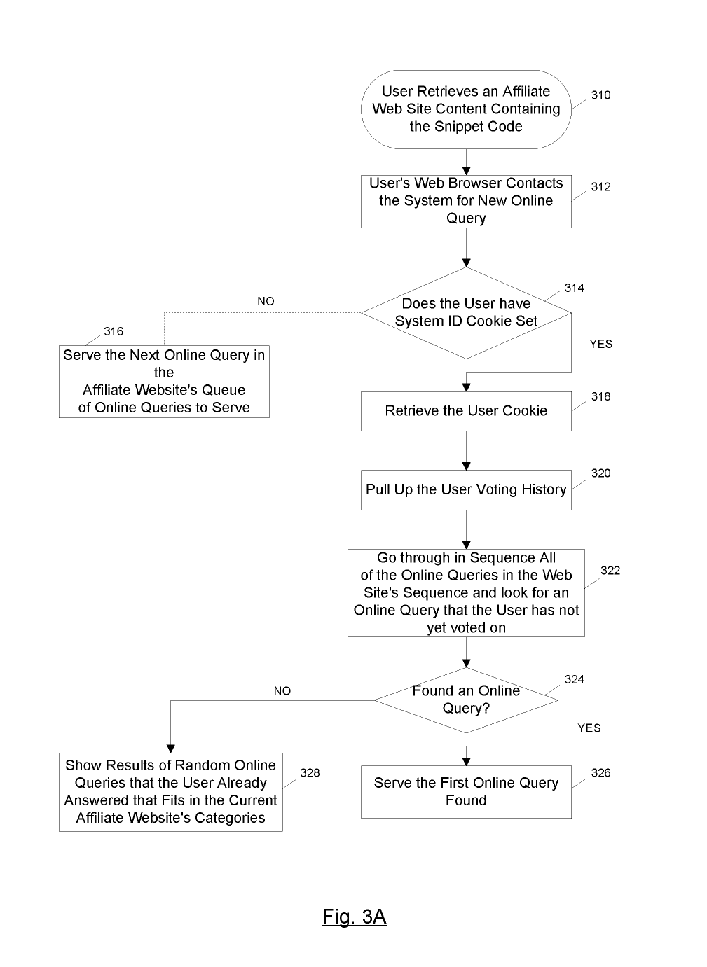

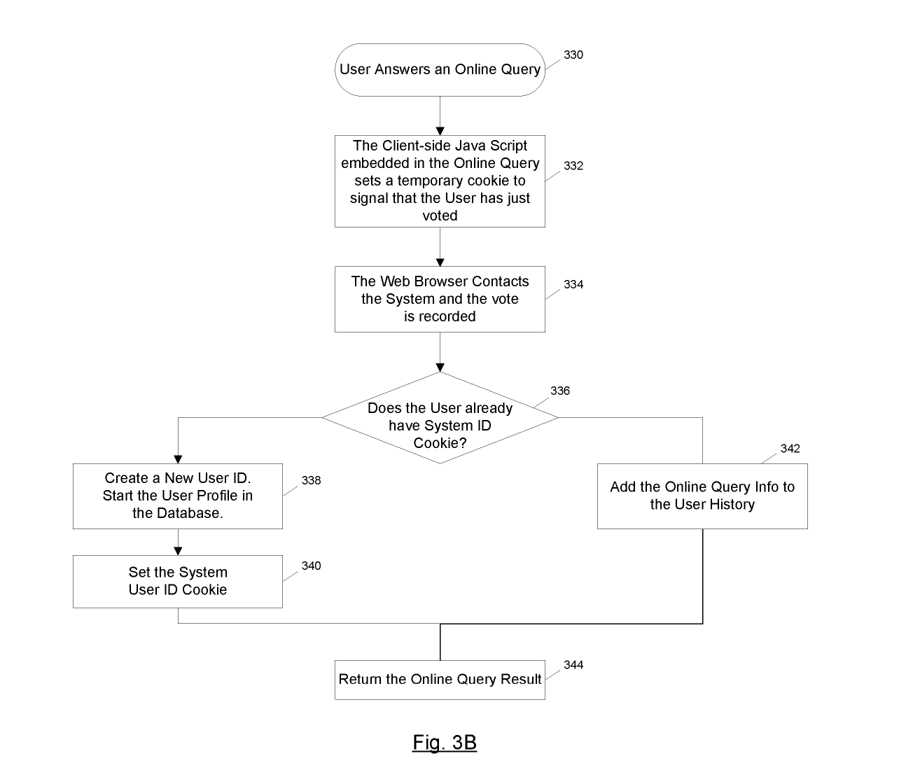

As such, referring to FIG. 3A, at step 310, when a user retrieves a specific Web page 160 (i.e., a particular URL) of an Affiliate Web site 170, the user's Web browser 112 contacts the System 120 for a new poll at step 312. Then, at step 314, the System 120 determines whether that user has previously interacted with a poll by searching for the System User ID cookie. If the user does not have a System User ID cookie, then the System serves the next poll in the Affiliate Web site's queue of polls to serve at step 316. In the case the user has a System User ID cookie set, then the System 120 retrieves the System User ID cookie at step 318 and pulls up the user's voting history at step 320. Next, at step 322, the System 120 goes through in sequence of all the polls in the Affiliate Web site's sequence and looks for a poll that the user has not yet voted. If such a poll is found at step 324, then the first of such poll found is served to the user computer 110 at step 326. Otherwise, if no such poll is found at step 324, then the System 120 proceeds to step 328 where the results of random polls that the user has previously answered and fits in the current Affiliate Web site's categories are shown.

Referring now to FIG. 3B, once the poll is delivered, the user interacts with the poll and answers the presented questions at step 330. Then, at step 332, the Client-side JavaScript embedded in the poll sets a temporary cookie to signal that the user has just voted. Next, at step 334, the user's Web browser 112 contacts the System 120 and the user's vote is recorded. The System 120 then determines whether the user already has a System User ID cookie at step 336. If the user does not have a System User ID cookie, the System 120 proceeds to step 338 where the new User ID and a new User Profile is created in the System database. Then at step 340 the System User ID cookie is set and the poll results are returned to the user's Web browser at step 344. If it is determined at step 336 that the user already has a System User ID cookie, the poll information is added to the user's voting history at step 342 and the poll results are returned to the user's Web browser at step 344.

Client Interface

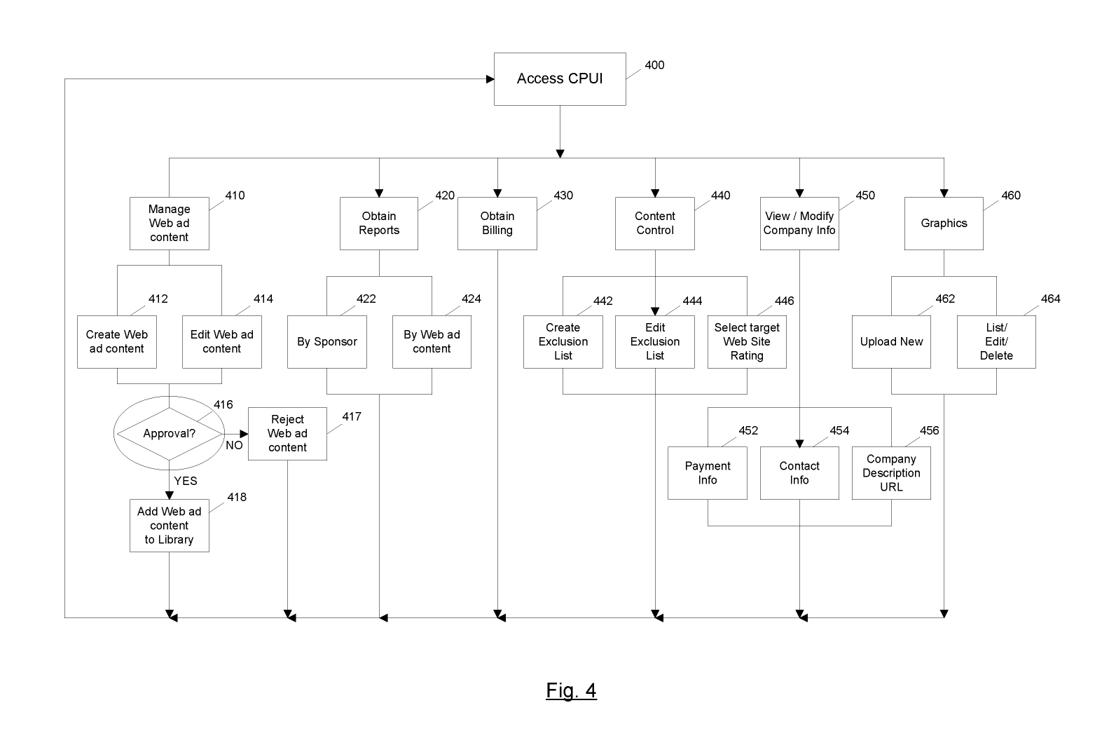

The present invention provides a forum in which Clients (i.e., Content Providers, Marketers, and Affiliates) utilize polling technology and targeted content to effectively conduct advertising and marketing campaigns. To facilitate the interaction of these several Clients with the System 120, the preferred embodiment of the invention provides a Client Interface to enable the Content Providers, Marketers, and Affiliates to perform the necessary functions within the System 120. The different processes that occur within the present embodiment when Content Providers utilize the Content Provider User Interface (“CPUI”) are described in FIG. 4. At step 400, when the Content Providers access the CPUI via the Web browser 190 on their computer 188, the Content Providers have several options available. Using the CPUI, the Content Providers can: (1) manage their polls; (2) obtain real-time reports on their content traffic; (3) obtain latest billing information; (4) control the display of their content; (5) update account information; and (6) manage their graphics/creatives library.

If a Content Provider selects the option of managing their polls, the System 120 proceeds to step 410. If the Content Provider wishes to create a new poll, the System will proceed to step 412 to create the new poll. At step 412, Content Providers are required to categorize and define the content rating for the poll that they create. On the other hand, if the Content Provider desires to edit a previously created poll, then the System 120 will proceed to step 414. Here at step 414, only the simplest modifications are allowed. If the poll changes are too drastic, the Content Provider will need to create 10 a new poll. Spelling errors or slight wording changes are situations in which modification of that poll is possible. However, Content Providers can neither delete an answer choice of a poll nor rephrase a poll question in a different way because such changes will taint the present voting record for that poll. Once the Content Provider has finished either creating or modifying a particular poll, the poll is then submitted for approval at step 416 to ensure that every piece of the created content is appropriate and categorized correctly. If the poll fails to meet the required criteria, the poll is rejected at step 417 and the Content Provider is led back to the CPUI at step 400. If the poll does meet the required criteria, then the poll is placed into the System Content Provider poll library within the database 130 and the Content Provider is led back to the CPUI at step 400. With such a strict approval process and organizational structure, the System Content Provider poll library serves as an invaluable tool at a later time, since potential sponsors search this library for the appropriate set of polls to sponsor.

Content Providers may also choose to receive real-time reports on their content traffic through the use of the CPUI. Upon the Content Provider's selection of this option, the System 120 proceeds to step 420 where the System 120 will provide reports on how the Content Provider's polls are performing and generating revenue. The data will display and analyze polls, sponsors, Web sites, responses, and Users. If the Content Provider selects a particular sponsor and a specific date range, the System 120 will proceed to step 422 and will furnish the following type reports: (i) number of impressions per poll; (ii) number of poll responses per poll; (iii) response yield percentage per poll; (iv) total number of poll impressions; (v) total number of responses; (vi) total response yield percentage; (vii) number of responses per answer choice; (viii) response yield percentage per answer choice; (ix) volunteered information such as answers to a specific question, mailing address, email address; (x) the different Web sites to which the polls were delivered; and (xi) the categories of the different Web sites to which the polls were delivered. Affiliate Web sites that display the various polls and advertisements are grouped into a plurality of different categories. In the preferred embodiment of the invention, for example, the categories are: (1) Autos; (2) Business and Finance; (3) E-Commerce and Shopping; (4) Entertainment; (5) Teens; (6) Women; (7) Health; (8) Home and Health; (9) Internet and Technology; (10) Web Related Services; (11) Lifestyle & Fashion; (12) Music; (13) News and Media; (14) Sports; (15) Travel & Weather; (16) Portal and Communities; and (17) Politics. All of the Affiliate Web Sites are required to select the category that best describes the content and user interest related to their Web site during the registration process. Below these main categories, there will also be sub-categories available to more accurately describe the various Web sites as the network of affiliates grows. The categorization process is used for Content Providers and Marketers to determine which Web sites should display their poll and advertisement campaigns.

If the Content Provider selects a particular poll and a specific date range, the System 120 will proceed to step 424 and will furnish the following type of reports: (i) number of impressions delivered; (ii) number of responses; (iii) number of responses per answer; (iv) response yield percentage; (v) response yield percentage per answer choice; (vi) list of sponsors; (vii) number of responses per sponsor; (viii) number of responses per answer choice per sponsor; (ix) response yield percentage per sponsor; and (x) response yield percentage per answer choice per sponsor. These reports enable the Content Providers to view which polls are popular and which are not, thus allowing the Content Providers to adjust their new content accordingly.

Content Providers may also receive the latest billing information through the CPUI. At step 430, the System 120 provides Content Providers with information concerning how much revenue they have earned from past and current periods, as well as other account and billing information. When the Content Provider selects a particular sponsor and a specific date range 432, the System 120 provides the following types of reports: (i) revenue calculated per sponsor per marketing campaign; and (ii) dollar amount representing the total number of poll responses by sponsored poll multiplied by the unit revenue per response.

There are other options available for Content Providers through the CPUI. If Content Providers choose to establish content control—decide as to what type of Web sites are able to host and display their content (“target Web sites”), the System 120 will proceed to step 440. As mentioned previously, in the preferred embodiment of the invention, Content Providers display their polls and advertising material on their own Web pages as well as on the Affiliate Web pages. Thus, it is important for the Content Providers to have control over which Affiliates host and display their polls and advertising content. There will be instances where Content Providers will not want their branded content being displayed at certain types of Web sites because of the content contained in those Web sites. For example, a movie studio that provides entertainment trivia polls may not wish that their logo, trademark, or other associated advertising material appear on adult-oriented Web sites. In order to facilitate this control, the System 120 at step 440 provides Content Providers with several content control choices. Upon choosing, a Content Provider may, at step 442, create a list (i.e., exclusion list) of Affiliate Web sites which should be excluded from hosting and displaying that Content Provider's polls and sponsored advertisements. In addition, the Content Provider may, at step 444, edit their pre-existing exclusion list.

The Content Providers can also select which Affiliates will display their polls and sponsored advertisements by setting a “Content Rating” range of target Web sites. In the preferred embodiment of the invention, all Affiliates are required to rate both the content and appropriate audience for the material appearing on their Web pages through an established Content Rating guideline (i.e., Rated G. PG-13, R. etc.). Thus, the System 120 allows Content Providers another option in addition to the direct exclusion lists to monitor which Affiliate Web sites will host and display their polls and advertisements. If Content Providers select to establish the Content Rating range of the target Web sites, the System 120 will proceed to step 446 where the System 120 allows Content Providers to establish the minimum and maximum Content Rating levels for its target Web sites.

It should be noted that in the preferred embodiment of the invention, each time a new Web site joins the Affiliate network, that new Affiliate will submit the content of its Web site, its content rating, and category to the System staff for review. Although the default setting in the present embodiment is to automatically include all new Affiliates (pending that the content of the Affiliate's Web site falls into the appropriate content rating requirements) to host the applicable Content Provider polls, the Content Providers may access the CPUI to turn off this default option. In the event a Content Provider chooses to turn off this default option, that Content Provider must then examine the list of new Affiliates and approve the list for content serving.

The System 120 also provides Content Providers the option of updating any of their company information. If the Content Providers wish to modify their company information, the System 120 proceeds to step 450. From this point, the System allows Content Providers to update their contact information at step 454, update payment method/information at step 452, and update company description/URL at step 456. Within the CPUI, Content Providers may also create new and modify pre-existing designs (“creatives”) that exist in their library of logos. If the Content Providers choose to make new designs or modifications, the System 120 proceeds to step 460. Upon the Content Provider's choice, the System 120 will proceed to step 462 to create new designs and upload them to the logo library or proceed to step 464 to add/remove old creatives. However, before the creatives are permanently saved to the logo library, the creatives must be approved by the System staff.

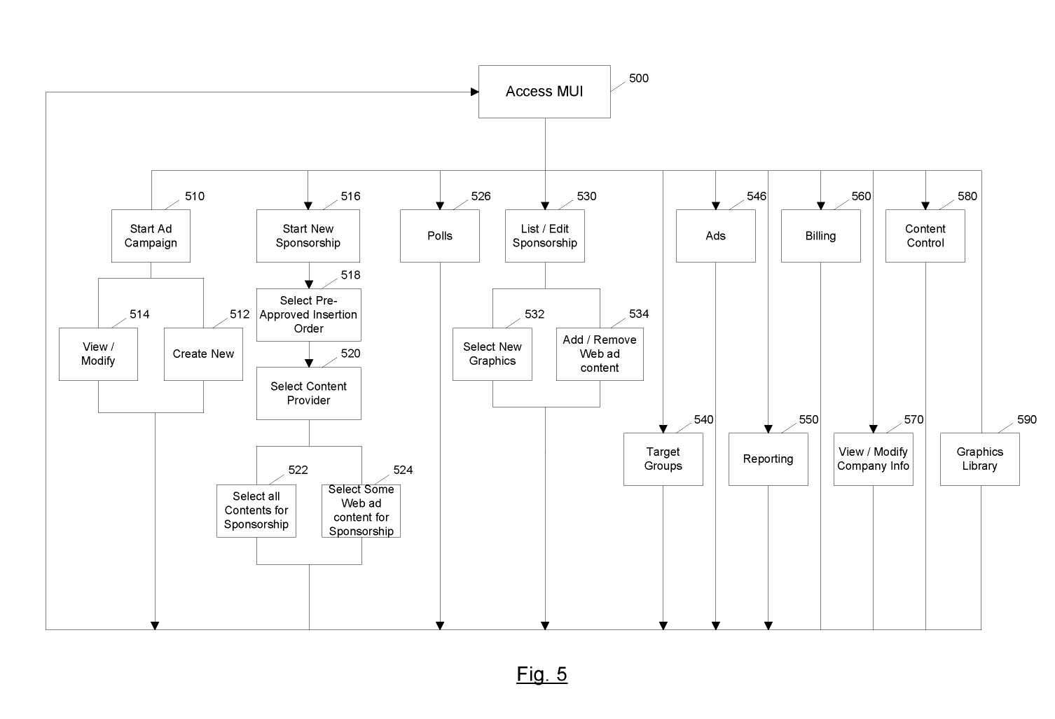

Referring to FIG. 5, the different processes that occur within the present embodiment of the invention as Marketers access the Marketer User Interface (“MUI”) are described. At step 500, through the MUI, the System 120 allows Marketers to: (1) start new marketing campaigns; (2) start new sponsorships; (3) manage their polls; (4) edit sponsorship content; (5) manage target groups; (6) manage the advertisement library; (7) obtain real-time reports of their polls and ads displayed; (8) obtain real-time billing information; (9) establish content control; (10) update account information; (11) and manage their graphics/creative library. If the Marketer selects to create/start a campaign, the System 120 will proceed to step 510 at which point the Marketer will have the option of creating a new campaign or viewing/modifying a previously created campaign. If the Marketer decides to create a new campaign, arrangements must first be structured offline. Once the offline arrangements have been made, the Marketer can select the create new campaign option and the System then proceeds to step 612 and requests the Marketer to submit an insertion order (IO). An insertion order is a legally binding document that defines the terms of the campaign. When a Marketer initiates their campaign with the System 120, they must first select the pre-approved (IO) campaign, then use the campaign creation tool/interface (explained later below) to define the details of the campaign. The campaign settings (i.e., poll content, category, Web sites, etc.) must be approved by the System staff before it is cached into the database 130. A Marketer will be able to modify a campaign at step 514 as long as the changes fall within the parameters of the original IO. Modifications will also need approval by the System staff before being implemented. Marketers may add/subtract polls, target groups, and ads.

To start a sponsorship, the arrangements must again be first structured offline. Once the offline arrangement have been made, marketers must choose the sponsorship option and proceed to step 516. The System 120 will then require the sponsors to submit an IO at step 518 before they can start a sponsorship campaign. When an IO is approved, the sponsors can then select the IO and choose the poll(s) or Content Provider that they would like to sponsor based on the IO terms at step 520. The System 120 will proceed to step 522 if the sponsor decides to sponsor all of the Content Provider's content or proceed to step 524 if the sponsor decides to sponsor specific selected polls. After the sponsor submits the request, the System staff is notified to obtain approval and authorization of the sponsorship between the sponsor and poll Content Provider.

If a Marketer selects to create new polls or modify pre-existing ones, the System 120 proceeds to step 526. As mentioned previously, there is a strict approval process in the creation of and modification of polls. The System staff must approve the poll (i.e., content, rating, category, etc.) before it is saved into their poll library. Once a poll is created, only the simplest modifications are allowed. Only specific aspects of polls can be modified without adversely affecting the integrity and results of that poll (e.g., cannot change or delete choices of a live poll, since past results screen and data will not match). If the poll changes are too drastic, the Marketers will need to create a new poll. Spelling errors or slight wording changes are acceptable modifications. In any event, the System staff must review all activities of poll creation and modification in order to ensure that the polling content is appropriate and that each poll is categorized correctly.

In case a Marketer selects to modify any sponsorship campaigns, the System 120 proceeds to step 530. There are only two modifications that a sponsor can make once a campaign has begun. Sponsors can either remove/upload a new logo creative that is attached to a particular poll's sponsor section at step 532 or add/remove sponsorship content from the Content Provider's poll list at step 534. Depending on how the sponsor selected the polls to sponsor, it will affect how the System 120 processes new content that is later added by a Content Provider. If the sponsor selected to sponsor all of the polls from a particular Content Provider, then any new content added by the Content Provider will be automatically accepted and sponsored. However, if only specific polls were selected, new content will not be automatically accepted and sponsored. The sponsor will have to continue to select specific polls—whether new or old—to sponsor those polls.

In order to run an effective marketing campaign, it is imperative that Marketers be able to pinpoint the target audience to whom specific advertisements will be directed. Thus, at step 540, Marketers may use the MUI to create target groups—an arbitrary list of users who have responded to polls and are created for targeting purposes. Marketers create target groups by selecting the poll questions and the possible response combinations for the group of Users the Marketers wish to target. Once the target groups have been created and named, they can be used for targeting any poll/ad campaign. For example, a Marketer can make a target group called “Users Who Invest Online” by selecting the question/answer combination of: Question—“Do you invest online?” and Answer—“Yes or No”. All of the respondents to this poll question and specific response will be the target group that receives future advertisements or polls from the advertiser as related to online investing options. The System staff will also be able to create target groups internally. In this manner, high quality target groups classified into different categories will be available for all Clients. The System staff will have access to all the profiles and will be able to eliminate clutter and identify the more valuable profiles for Marketers to target.

Marketers may also manage their ad library using the MUI. Upon the Marketer's selection of this option, the System 120 proceeds to step 546. This function allows the advertiser to upload ad banners into their own library. Once the ad banner is uploaded, the System staff must approve the ad banner before it is cached in the database 130. All ad banners will be rated based on content, in order to match Web site interests and requirements. After the ad banner has been loaded into the library and approved, it is ready for use in any marketing campaign.

Other options available for Marketers through the MUI include obtaining real-time reporting of polls/ads displayed 550, obtaining real-time billing information 560, updating company information 570, establishing content controls 580, managing the graphics/creative library 590. Since these functions operate in the same manner as described above for Content Providers, the details of their operation will not be repeated here.

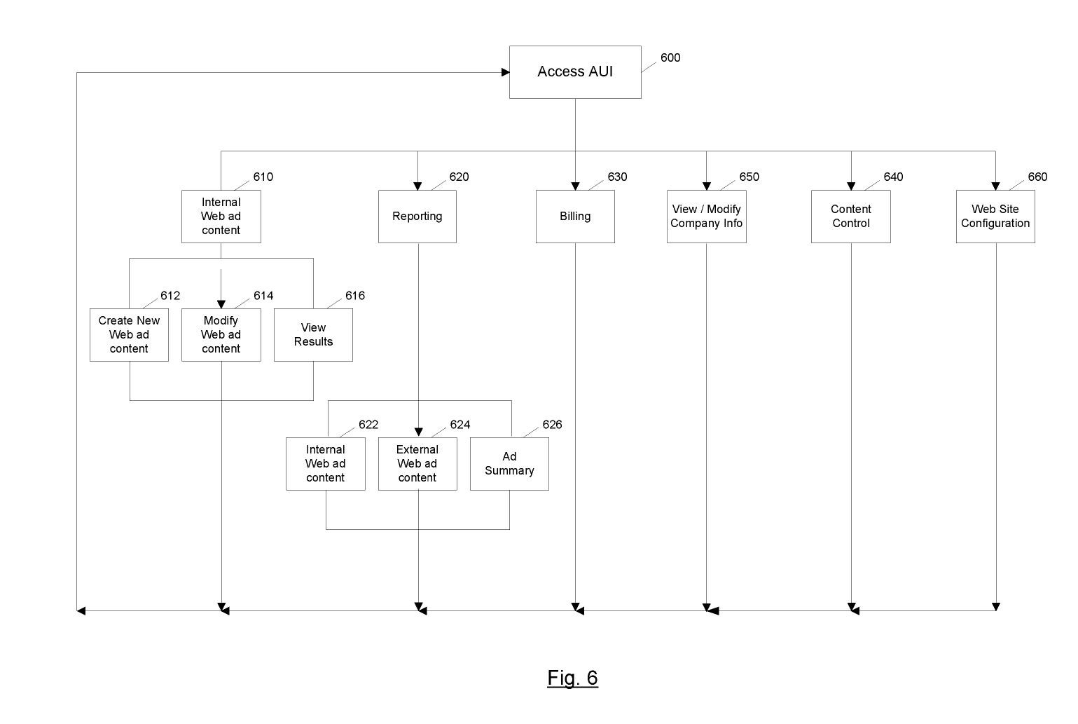

The current advertising approach becomes more effective when more Web sites become Affiliates to the System 120. In order to attract numerous Web sites to join the network of Affiliates and use the System 120, the System 120 provides the Affiliates with the right tools and technology to host polls that generate revenues on a per-response basis. To better understand the tools available for Affiliates, the different processes that occur within the present embodiment of the invention as Affiliates access the Affiliate User Interface (“AUI”) are described in FIG. 6. At step 600, through the AUI, the System 120 allows Affiliates to: (1) either create and display their own internal polls; (2) generate revenue through the display of external polls made by Content Providers, Marketers, or sponsors; (3) configure their Web site; (4) obtain real-time reports on their content traffic; (5) obtain the latest billing information; (6) monitor what types of polls or advertisements may appear on their Web pages; and (7) update its account information.

If Affiliates select to create new internal polls within the AUI, the System 120 proceeds to step 610. From step 610, the Affiliate may create a new poll at step 612, modify an existing poll at step 614, or view the results of their internal polls at step 616. The Affiliate User Interface 600 (“AUI”) is unique in that unlike any other user interface, the AUI allows the Affiliates to modify their internal polls at step 614 whenever and however they like. Unlike external polls, internal polls may be changed in any manner upon the Affiliate's choosing. Affiliates may even implement changes that taint the tally results of the poll responses since it is an internal poll and the decision is solely on that Affiliate. Thus, Affiliates can rephrase poll questions and add/delete poll response choices.

Since Affiliates will most likely be concerned with the polls aesthetically matching and blending with the rest of the content on their site, the System 120 will allow Affiliates to enter all of the necessary parameters needed to achieve the right look. Specifically, the Affiliates can control the border, background, fonts, sizes, colors for every part of the poll—header, question, responses, disclaimers, privacy, and graphical sections. The Affiliates can also set the default disclaimers for terms of use, privacy, or other rules or have links to Web pages displaying the disclosures that they need to provide users. All of these features will be available in the affiliate user interface (AUI) described below. The System 120 will also provide Affiliates with a preview opportunity to view their polls before submission into the database 130. However, even the Affiliates will not be allowed to implement changes to polls that would adversely affect the integrity and results of that poll (e.g., cannot change or delete choices of a live poll, since past results screen and data will not match).

The AUI also enables Affiliates to obtain real-time reports on their content traffic. The reporting section 620 will report various aspects of polling activity and ad delivery on their Web site. Affiliates will be able to view real-time reporting on internal polls 622, external polls 624, and banner ad performance 626 displayed throughout their site. The AUI provides another important feature by providing Affiliates the ability to place the necessary snippet code in their HTML document to display the appropriate polls/ads. When an Affiliate decides to place a poll 162 in their Web page 160, the Affiliate must install a HTML code into the Web page 160 at step 660.

Similar to the functions of the other user interfaces, the AUI provides Affiliates with the tools for obtaining the latest billing information at step 630 to keep track of the amount of revenue earned from external poll and ad delivery, for establishing content controls at step 640 to monitor which types of sponsors and advertisements are displayed on its Web pages, and for updating its account information at step 650. Since Affiliate Web sites will have an interest in monitoring what types of polls or advertisements may appear on their Web pages, the System 120 will require Content Providers to rate both the content and the appropriate audience for all of its poll content and advertisements through the previously mentioned Content Rating system. As such, the System 120 at step 640 will allow Affiliates to establish the Content Rating range such that only those materials that fall within that predetermined minimum and maximum range may appear on their Web pages.

Campaign Creation Tool/Interface

In order to create the marketing campaign which drive the present invention, Marketers (and Content Providers for the purposes of generating branded content polls) are provided the options of creating, modifying, deleting, and viewing a campaign. To do so, a Marketer accesses a marketing campaign management tool accessible via the Internet to Marketers who register and create personal accounts. Once in the marketing campaign management tool, the Marketer can choose to create a marketing campaign. The Marketer is then presented with three options of creating: (1) an advertisement campaign; (2) a poll campaign; or (3) a campaign having a combination of both polls and advertisements.

An advertisement campaign is created by having the Marketer define for the campaign: (1) a title; (2) a start date; (3) an end date; and (4) a set of advertisements and selecting an order, weight, or other selection parameter to each ad and a target group to whom each ad should be delivered or other target criteria, such as a particular type of Web site. A poll campaign is created by having the Marketer define for the campaign: (1) a title; (2) a start date; (3) an end date; and (4) a poll question having up to six possible responses, and selecting a target group to whom each poll should be delivered or other target criteria, such as a particular type of Web site. Depending on the type of poll(s) used in the poll campaign additional parameters need to be defined, such as specific answers to a trivia poll question or topics of a mini-survey. A poll campaign integrated with advertisements is created by having the Marketer create for the campaign: (1) a title; (2) a start date; (3) an end date; and (4) a poll question having up to six possible poll responses, and assigning the paring of advertisements to certain poll responses and selecting an order, weight or other selection parameter to each ad, and a target group to whom each ad should be delivered or other target criteria, such as a particular Web site type.

Revenue Model

In a further embodiment of the present invention, a novel revenue model is incorporated to encourage many Web sites to become Affiliates. As discussed, the present invention delivers polls to Affiliate Web sites. Such polls can be designed by Marketers who will be able to create polls having a question and up to six possible responses. The poll is designed to appeal to and elicit answers from potential buyers of a particular product or service (i.e., potential qualified leads). Once a user responds to a poll by submitting a response, the user becomes a “qualified lead”. For enabling the generation of this qualified lead, the Marketer will pay a fee for each lead generated. Affiliates who received and displayed the poll question that generated the lead will receive a portion of that fee. Therefore, in an example where the cost of a lead is $1.00, paid by the Marketer, an Affiliate could earn $0.25 every time it generates such a lead by exposing each of its Web site viewers to a poll and having each viewer answer that poll. Content providers will also share in the stream of revenues when Marketers use branded poll content in their campaigns. In short, the present invention provides Affiliates with diverse polls and sticky content (branded content, direct response—marketing related, profile related, entertainment/trivia, etc.), and pays them for each response.

When the qualified lead surfs to another Affiliate Web site, a targeted advertisement based on their previous poll responses (i.e., declared preferences), will be delivered to that user. Marketers are able to associate up to five different ads per set of declared preferences and are able to provide criteria that will determine which ad should be delivered to a given qualified lead. For delivering an ad to a qualified lead, the Marketer will pay a fee. The Affiliate that displayed the delivered ad will receive a portion of that fee and the Affiliate that first generated the qualified lead by displaying the poll will also receive a portion of that fee (a residual referral fee). For example, where the cost of delivering an ad to a qualified lead is $0.50, the Affiliate Web site receiving and displaying the ad may receive $0.25, and the Affiliate Web site that first generated the lead by displaying the poll may receive $0.10. It should be appreciated that other revenue models could be used in combination with the poll and ad delivery system and marketer campaign management system. The example provided above is just one illustration of how the pricing may be set and the actual prices may vary from one Client to another.

It should be noted that the interaction with online polls creates ideal opportunities for a performance-based pricing model (i.e., charging per response). With banner ads and other forms of online ads, performance-based pricing occurs on a “click-through” basis. Most Web publishers oppose this pricing model since advertisers often receive “free” exposure of the ads or brands when user click-throughs do not occur. Online polls are the perfect solution to this problem, since polls may be tailored so that only the poll question and its answer choices are initially displayed, without ads or advertisers' brands being shown. The advertisers have an opportunity to display their message only after a user responds to the poll question. Therefore, advertisers get charged every time their message or brands get exposure and the Web publishers no longer face the “free” exposure problem.

Modification of User Profiles

In a yet further embodiment of the invention, Users are given the opportunity to modify their own profile characteristics. Users are encouraged to refine and extend their profiles so that targeted content delivered to each user will be more relevant and useful. Users may access a Web site dedicated to viewing, modifying, deleting, or adding poll responses that best describe and fit their interests and preferences. When a user accesses this Web site, they are presented with a very typical portal interface. If the user has a System User ID cookie in their Web browser 112, then the System 120 will read the cookie, identify the specific user, and present the user's personal profile. That user will then be able to look at past polls that he previously answered and can change those preference if desired. The System 120 will also present the user with an option to browse through previously unanswered polls and ask the user to answer those polls if desired. Thus, the System 120 will enable users to control the content of their online ads and polls delivered to them within the network of Affiliate Web sites.

### CONCLUSION

Having thus described a preferred embodiment of the method and apparatus for delivering targeted advertising and content based on user interaction with online queries on a wide area network, it should be apparent to those skilled in the art that certain advantages have been achieved. It should also be appreciated that various modifications, adaptations, and alternative embodiments thereof may be made within the scope and spirit of the present invention. The invention is further defined by the following claims.

What is claimed is:

1. A method for interactive delivery of advertisement units to a web browser, comprising:
requesting a webpage from an affiliate content server;
receiving the webpage in the web browser, wherein the webpage includes a request for a first advertisement unit;
rendering the webpage in the web browser, wherein the rendered webpage includes a designated space for advertisement units;
sending the request for the first advertisement unit to an advertisement server;
receiving the first advertisement unit;
rendering the first advertisement unit within the designated space for advertisement units;
interacting with the first advertisement unit;
sending details of the interactions to the advertisement server;
selecting a second advertisement unit based on the details of the interaction with the first advertisement unit;
sending the second advertisement unit to the web browser; and
rendering the second advertisement unit within the designated space for advertisement units.

2. The method for interactive delivery of advertisement units to a web browser, as recited in claim 1, further including:
building a user profile based on the user's interactions with the first advertisement unit; and
embedding a cookie on the web browser to identify the user with the user profile.

3. The method for interactive delivery of advertisement units to a web browser, as recited in claim 1, further including updating a user profile based on the user's interactions with the first advertisement unit.

4. The method for interactive delivery of advertisement units to a web browser, as recited in claim 1, wherein the first advertisement unit is an online query.

5. The method for interactive delivery of advertisement units to a web browser, as recited in claim 1, wherein the second advertisement unit includes a summary of results from the online query.

6. The method for interactive delivery of advertisement units to a web browser, as recited in claim 1, wherein the second advertisement unit is an online query.

7. The method for interactive delivery of advertisement units to a web browser, as recited in claim 1, wherein the second advertisement unit is related to the first advertisement unit.

8. The method for interactive delivery of advertisement units to a web browser, as recited in claim 1, wherein the request is an embedded script.

9. The method for interactive delivery of advertisement units to a web browser, as recited in claim 8, wherein the embedded script is programmed in JAVASCRIPT.

10. The method for interactive delivery of advertisement units to a web browser, as recited in claim 1, wherein the first advertisement unit and the second advertisement unit has an audience rating.

11. The method for interactive delivery of advertisement units to a web browser, as recited in claim 1, wherein the audience ratings of the first advertisement unit and the second advertisement unit do not exceed an audience rating level of the web page.

12. The method for interactive delivery of advertisement units to a web browser, as recited in claim 1, wherein the audience ratings of the first advertisement unit and the second advertisement unit do not exceed an audience rating level of the affiliate content server.

13. A system for interactive delivery of advertisement units, comprising:
a client web browser configured to render a web page having a designated location for a first advertisement unit, wherein the first advertisement unit is configured to enable user interactions and submission of user interaction data via a submit function;
an advertisement unit database element configured to store a plurality of advertisement units; and
an advertisement unit server element communicatively connected to the client web browser and the advertisement unit database element, the advertisement server element configured to:
receive the user interaction data,
search the plurality of advertisement units in the advertisement unit database element for a second advertisement unit based on the user interaction data, and
send the second advertisement unit to the client web browser to replace the first advertisement unit in the designated location of the web page.

14. The system for interactive delivery of advertisement units, as recited in claim 12, wherein the advertisement unit database element and the advertisement unit server element reside in a single computing device.

15. The system for interactive delivery of advertisement units, as recited in claim 12, wherein the advertisement unit database element and the advertisement unit server element reside in different computing devices.

16. The system for interactive delivery of advertisement units, as recited in claim 12, wherein the first advertisement unit is an online query.

17. The system for interactive delivery of advertisement units, as recited in claim 12, wherein the second advertisement unit is an online query.

18. The system for interactive delivery of advertisement units, as recited in claim 12, wherein the second advertisement unit is related to the first advertisement unit.

19. The system for interactive delivery of advertisement units, as recited in claim 12, wherein the request is an embedded script.

20. The system for interactive delivery of advertisement units, as recited in claim 12, wherein the first advertisement unit and the second advertisement unit has an audience rating.

21. The system for interactive delivery of advertisement units, as recited in claim 19, wherein the audience ratings of the first advertisement unit and the second advertisement unit do not exceed an audience rating level of the web page.

22. The system for interactive delivery of advertisement units, as recited in claim 12, wherein each of the plurality of advertisement units stored in the advertisement unit database element are approved prior to storage.

23. The system for interactive delivery of advertisement units, as recited in claim 12, wherein a user profile is created within the within the advertisement unit server element and configured to store the user interaction data.

24. The system for interactive delivery of advertisement units, as recited in claim 12, wherein the first advertisement unit is configured to embed a cookie onto the web browser to identify a user with the user profile.

25. The system for interactive delivery of advertisement units, as recited in claim 23, wherein the user profile is updated whenever new user interaction data is submitted.
